(19) United States
(12) Patent Application Publication
(10) Pub. No.: US 2021/0216941 A1
(43) Pub. Date: Jul. 15, 2021

(54) INFLUENCE BASED ATTRITION

(71) Applicant: International Business Machines Corporation, Armonk, NY (US)

(72) Inventors: Jagadeesh Pataballa, Visakhapatnam (IN); Venkata Vara Prasad Karri, Visakhapatnam (IN); Kamal Kiran Trood Yamala, Visakhapatnam (IN); Sushil Bhaskar Ravi, Visakhapatnam (IN); Sai Rama Penmatsa, Visakhapatnam (IN)

(21) Appl. No.: 16/738,487

(22) Filed: Jan. 9, 2020

(51) Int. Cl. G06Q 10/06; G06Q 10/04

(52) U.S. Cl. CPC G06Q 10/06398; G06Q 10/04

(57) ABSTRACT

A method, computer program product and computer system are provided. A processor retrieves information regarding a plurality of employees of an organization. A processor determines an attrition rating for each of the plurality of employees. A processor determines a contribution rating for each of the plurality of employees. A processor determines an influence rating for each of the plurality of employees. A processor generates a predicted attrition report for the plurality of employees based, at least in part, on the attrition rating, the contribution rating, and the influence rating for each of the plurality of employees.

### BACKGROUND OF THE INVENTION

The present invention relates generally to the field of predictive turnover, and more particularly to impacts to predictions of turnover based on influence.

Turnover, churn or attrition is the concept of an organization losing and replacing members of a workforce. Turnover may occur when an employee leaves or is terminated from an organization. Turnover rate, the ratio or percentage of employees that leave, is an important metric for organizations to track and predict in order to ensure to efficiency and competitiveness of the organization.

### SUMMARY

Embodiments of the present invention provide a method, system, and program product to determine influence-based attrition. A processor retrieves information regarding a plurality of employees of an organization. A processor determines an attrition rating for each of the plurality of employees. A processor determines a contribution rating for each of the plurality of employees. A processor determines an influence rating for each of the plurality of employees. A processor generates a predicted attrition report for the plurality of employees based, at least in part, on the attrition rating, the contribution rating, and the influence rating for each of the plurality of employees.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIG. 2 illustrates operational processes of a turnover program, on a computing device within the environment of FIG. 1, in accordance with an exemplary embodiment of the present invention.

FIG. 3 depicts a block diagram of generating a turnover report.

FIG. 4 depicts a block diagram of components of the computing device executing a turnover program, in accordance with an exemplary embodiment of the present invention.

### DETAILED DESCRIPTION

While solutions to turnover predictions are known, they typically base predictions of turnover based on historic turnover rates. Embodiments of the present invention recognize that, by utilizing predictive models that account for the influence or impact employees have within an organization, improvements to the accuracy and effectiveness of turnover predictions is provided. By generating predictive models that use both internal and external data to the organization, embodiments of the present invention determine the influence or impact employees have to other members of the organization. Embodiments of the present invention recognize that the attrition of more influential employees, or in some embodiments—departments, can impact the turnover of other employees. By providing for predictive models that account employees impact within an organization, embodiments of the present invention provide improvements to the accuracy to known turnover predictions.

Embodiments of the present invention provide for the reporting and prediction of attrition, not only on historic information, but influence of certain cases of predicted employee turnover has on an organization. Embodiments of the present invention are not directed towards the re-assignment, management or instruction of employees. Embodiments of the present invention instead provide reporting tools for the organization to utilize, which that may result in the organization participating in the re-assignment, management or instruction of employees, of which are not provided by embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

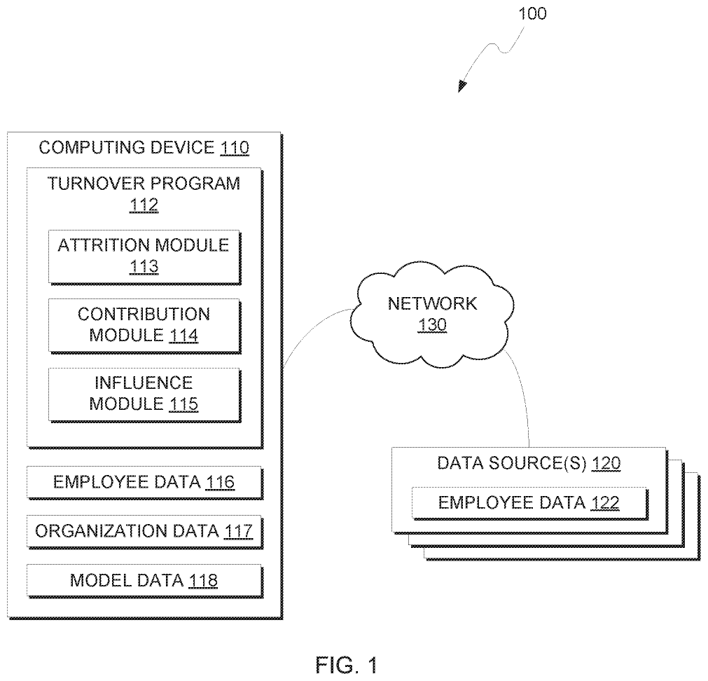

The present invention will now be described in detail with reference to the Figures. FIG. 1 is a functional block diagram illustrating networked environment, generally designated 100, in accordance with one embodiment of the present invention. Networked environment 100 includes computing device 110 and data source(s) 120 connected over network 130. Computing device 110 includes turnover program 112, employee data 116, organization data 117 and model data 118. Turnover program 112 includes attrition module 113 contribution module 114 and influence module 115. Data source(s) 120 include employee data 122.

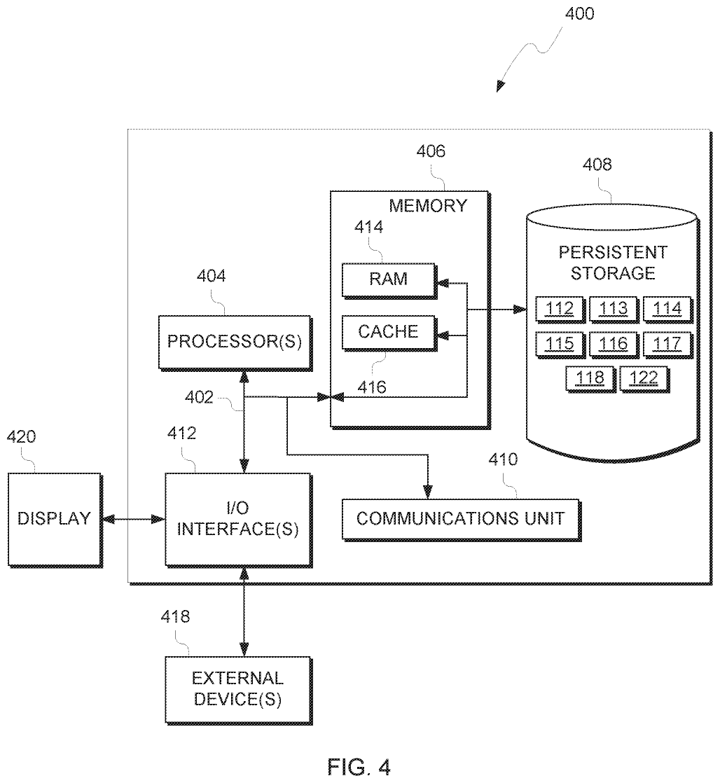

In various embodiments of the present invention, computing device 110 and data source(s) 120 can be a standalone device, a server, a laptop computer, a tablet computer, a netbook computer, a personal computer (PC), or a desktop computer. In another embodiment, computing device 110 and data source(s) 120 can each represent a computing system utilizing clustered computers and components to act as a single pool of seamless resources. In general, computing device 110 and data source(s) 120 can be any computing device or a combination of devices with access to turnover program 112, employee data 116, organization data 117, model data 118 and employee data 122 is capable of executing turnover program 112. Computing device 110 and data source(s) 120 may each include internal and external hardware components, as depicted and described in further detail with respect to FIG. 4.

In this exemplary embodiment, turnover program 112, employee data 116, organization data 117 and model data 118 are stored on computing device 110 and employee data 122 is stored on data source(s) 120. However, in other embodiments, turnover program 112, employee data 116, organization data 117, model data 118 and employee data 122 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110 and data source(s) 120, in accordance with a desired embodiment of the present invention.

In various embodiments, turnover program 112 determines a prediction, projection or estimate of a future turnover rate for an organization—or department, group or team thereof. Based both on each employee's contribution and influence on the organization, as well as said employee's contribution and influence on other employees, turnover program 112 generates various reports regarding predicted changes in turnover or attrition within the organization, or group thereof—such as, but not limited to, (i) a prediction or likelihood for an employee to leave the organization, as well as the impact and influence said employee has one other employees; (ii) a predicted attrition or turnover rate for the organization, or group thereof, based on the predicted attrition; (iii) a predicted impact on profitability or production for the organization, or group thereof, based on the predicted attrition; and (iv) a predicted impact on tasks or workflow for the organization, or group thereof, based on the predicted attrition.

In various embodiments, turnover program 112 determines an attrition rating for each employee based on the probability that an employee may leave an organization. Attrition module 113 of turnover program 112 determines the likelihood that an employee will leave an organization with a given time period. For example, if turnover program 112 is tasked with generating a turnover prediction for the next quarter, then attrition module 113 determines the probability that each employee may leave the organization during the next quarter.

In various embodiments, turnover program 112 determines a contribution rating for each employee that indicates the contributions the employee makes to the organization or department. In some embodiments and scenarios, contribution module 114 of turnover program 112 determines the contribution of each employee based on a profitability or revenue metric attributed to the employee. In other embodiments and scenarios, contribution module 114 of turnover program 112 determines the contribution of each employee based on the responsibilities or tasks the employee performs on behalf of the organization.

In various embodiments, turnover program 112 determines an influence rating that indicates the impact an employee has on other employees within the organization. Influence module 115 of turnover program 112 determines the influence of an employee based on organization data 117 as well as internal employee data 116 and external employee data 122. Organization data 117 includes information indicative of the organization's structure and the interactions or relationships each employee has with other employees within the organization. Internal employee data 116 includes information maintained by the organization indicative of each employee's (i) current and previous responsibilities (e.g., job title(s) and tasks assigned to the employee), (ii) experience and qualifications (e.g., education and experience), and (iii) performance reviews (e.g., manager or peer reviews of the employee).

External employee data 122 includes information provided from data source(s) 120 that are indicative of employee influence or interactions with other employees as well as with non-employees of the organization. For example, a data source of data source(s) 120 includes external employee data 122 that indicates the followers of the employee on a social networking or media website or platform. As another example, a data source of data source(s) 120 includes external employee data 122 that indicates various blog posts or other articles that mention the employee. As another example, a data source of data source(s) 120 includes external employee data 122 that indicates various research or whitepapers that include the employee as an author, cite an article by the employee or otherwise mention the employee.

In various embodiments, turnover program 112 generates a turnover report based on the attrition rating, contribution rating and influence rating of the employees for the organization, or department or any grouping of employees—such as a team. Based on model data 118, turnover program 112 determines the employees that may leave due to attrition as indicated by attrition module 113. Based on the contribution rating and influence rating, determined by contribution module 114 and influence module 115, respectively, turnover program 112 generates model data 118 which represents the impact the possible turnover will have on other employees for which the report is generated. Based on the influence of each employee, turnover program 112 generates model data 118 that indicates the connections and impact each employee has one other employees within the organization or group.

In various embodiments, turnover program 112 determines the impact an employee leaving has on other employees, if a given employee is predicted to leave in a given report period or within some pre-determined amount of time in the future. Based on the influence rating and interactions of employees represented by model data 118, turnover program 112 determines if other employees may leave based on the prediction of an employee leaving.

In various embodiments, turnover program 112 generates additional reporting based on the predicted attrition in addition to those employees who may be influenced to leave based on the predicted attrition, which results in a new influence-based attrition rate determination used in reporting. Example reports include, but are not limited to, reports regarding the new influence-based attrition rate, profitability or revenue changes that may be incurred based on the influence-based attrition rate, and individualized influence rating on a per-employee or per-group basis.

In various embodiments, turnover program 112 provides a user interface to display and configure an interactive user-interface based on the generated predicted attrition reports, as discussed herein. Turnover program 112 provides a user interface that displays various filters, search criteria, or other user interface elements to enable user-provided configurations of the reports generated by turnover program 112. For example, turnover program 112 includes user-interface elements that allow a user to select predicted attrition reports for a department or group within the organization. As another example, turnover program 112 includes user-interface elements that allow a user to select different time periods for display or comparison (e.g., monthly reports or quarterly reports). One of ordinary skill in the art will appreciate that turnover program 112 may provide a variety of filtering and configuration options for the displayed predicted attrition reports without deviating from the invention.

In various embodiments, turnover program 112 is configured to provide alerts or alarms based on the information generated in the predicted attrition reports. Turnover program 112 includes various user-interface elements that permit a user to configure an alarm or message to be sent to a user given certain conditions being present in a predicted attrition report. For example, turnover program 112 is user-configured to provide an alert if the predicted attrition rating for the next quarter exceeds a threshold value. As another example, turnover program 112 is user-configured to provide an alert if an employee's impact on predicted attrition is above a certain threshold value. One of ordinary skill in the art will appreciate that turnover program 112 may provide a variety of customizable alerts and messages for the predicted attrition reports without deviating from the invention.

In some embodiments and scenarios, turnover program 112 collects internal employee data 116 or external employee data 122 that includes posts, statements, discussions or messages regarding the employee's work at the organization. Turnover program 112 extracts the message (e.g., a video or audio post is converted to text) and performs natural language processing (NLP) on the message to determine the content of the message—indicating that the message is directed towards work at the organization. Turnover program 112 performs sentiment analysis to determine the sentiment or connotation represented by the message. In such scenarios, turnover program 112 assigns a higher attrition rating to employees that make negative-sentiment statements about the organization or group.

In some embodiments and scenarios, organization data 117 includes a listing of tasks or projects that are performed or worked on by employees, along with information indicating the tasks or projects assigned to the employees. Additionally, organization data 117 includes information indicative of the criticality or importance of the tasks or projects. In such embodiments and scenarios, turnover program 112 determines the impact of the influence-based attrition rate has to the tasks or projects. Turnover program 112 may generate alerts for more critical tasks or projects in the reporting with lower attrition rates than other less critical projects or tasks. Additionally, reports generated by turnover program 112 may also include a breakdown of influence-based attrition for the various tasks or projects assigned to the employees.

In some embodiments and scenarios, organization data 117 includes information indicative of the workforce requirements (e.g., a known skill set—necessary to perform the various tasks or projects performed by the organization—and number of employees possessing the skill set within the organization) for the organization. In such embodiments and scenarios, turnover program 112 generates a report indicating the projects or tasks affected by influence-based attrition and when said projects or tasks may be at risk of being understaffed based on the predicted influence-based attrition.

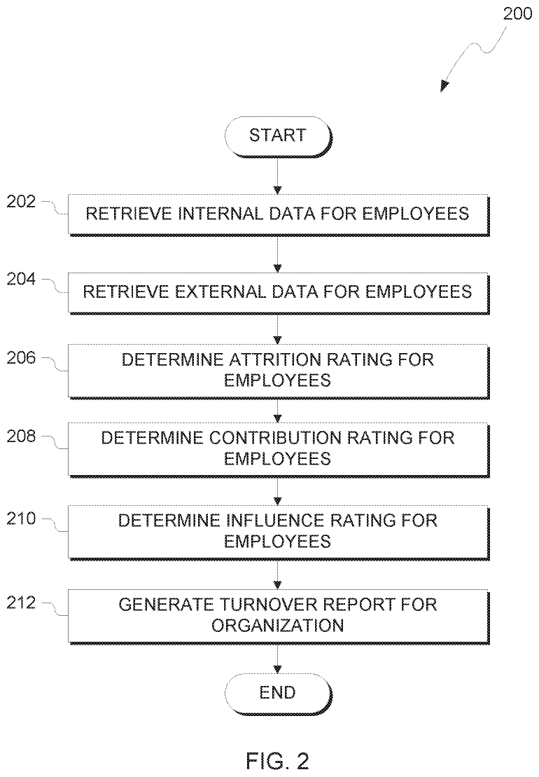

FIG. 2 illustrates operational processes of turnover program 112, generally designated 200, on computing device 110 within the environment of FIG. 1. In process 202, turnover program 112 retrieves internal employee data 116 regarding employees of the organization or group thereof. Example internal employee data 116 includes, but is not limited to, current and previous responsibilities, experience and qualifications and performance reviews. In process 204, turnover program 112 retrieves external employee data 122 from data source(s) 120 that are external to the organization. Example external employee data 122 includes, but is not limited to, social media posts, membership to organizations or trade groups, news articles, research papers and any article or publication. In some embodiments, internal employee data 116 may include information similar to that of external employee data 122. For example, some organization may have internal publications (e.g., internally distributed magazines) or internal social networks or messaging platforms.

In process 206, turnover program 112 determines an attrition rating for each employee in the organization or group for which a turnover report is to be generated. The attrition rating indicates the likelihood that a particular employee may leave the organization during a future time period for which the turnover report is being generated. Based on the both internal employee data 116 and external employee data 122, turnover program 112 determines an attrition rating based on the likelihood of an employee leaving the organization. Example internal employee data 116 that turnover program 112 may utilize in the determination of the attrition rating for an employee includes, but is not limited to, current band, grade or step within the organization, joining band or grade, date of joining, work and education experience, current assignment in the organization, and employee type (i.e., full-time or part-time). Additionally, turnover program 112 compares one or more of the above to historic attrition data either for the organization or similar positions within the industry. Example external employee data 122 that turnover program 112 may utilize in the determination of the attrition rating for an employee includes, but is not limited to, comments or messages regarding the organization or the employee's position or job (e.g., NLP and sentiment analysis of posts made by the employee), mentions of the employee in publicly available information (e.g., NLP and sentiment analysis to determine possible impact in continued employment), and industry trends indicated in news articles (e.g., NLP to determine events that may impact similar employees or locations).

In process 208, turnover program 112 determines a contribution rating for each employee in the organization or group for which a turnover report is to be generated. In some scenarios, turnover program determines a profit or revenue contribution of the employee. Based on internal sales or revenue data along with the projects or tasks performed by the employee, turnover program 112 determines a contribution rating for the employee. In other scenarios, based on the position or responsibilities of the employee, turnover program 112 identifies a criticality or importance to the employee based on organization data 117. Based on the how critical or important the employee is to the goals of the organization, turnover program 112 determines a contribution rating for the employee.

In process 210, turnover program 112 determines an influence rating for each employee in the organization or group for which a turnover report is to be generated. The influence rating indicates the influence or impact one employee has over other employees within the organization. The more employees impacted or influenced by an employee, the higher the influence rating for the employee. The turnover of a highly impactful or influential employee may result in more turnover from coworkers or subordinates. Turnover program 112 determines an influence rating for each employee in the organization or group based on at least one of the following: internal or external followers in a social network or forum, public or private publications or articles created by or mentioning the employee, and organizational data 117 that indicates the reliance or impact the employee has within the organization.

In process 212, turnover program 112 generates a report indicating expected attrition, in addition to attrition that may occur based on the turnover of certain employees (e.g., influenced-based attrition). Based on the attrition rating for each employee (process 206), turnover program 112 determines which employees that are likely to leave during the time period of the report. For example, when the attrition rating for an employee exceeds a predetermined value, then turnover program 112 identifies that employee to likely leave during the reporting period. For each employee likely to leave, the contribution rating (process 206) and impact rating (process 208) of the employee are identified and the impact of the employee's potential departure is propagated to other employees. Model data 118 includes a graph-based model of interconnections and relationships among employees, where nodes of the graph represent employees and paths represent business relationships or interactions among the employees. Based on model data 118, the attrition of one employee propagates and impacts the potential attrition rating of the interconnected employees. For precited-to-leave employees with high influence ratings, turnover program 112 increases the impact the of the attrition greater than precited-to-leave employees with low influence ratings. Additionally, contribution rating also impacts the propagation of turnover in model data 118. For employees with a smaller contribution rating, turnover program 112 lessens the impact of attrition to interconnected employees in model data 118. Based on the predicted attrition and impacted-attrition (e.g., those employees whose attrition rating was increased based on propagation of attrition in model data 118), turnover program 112 generates a report indicating expected attrition, in addition to attrition that may occur based on the turnover of certain employees (e.g., influenced-based attrition).

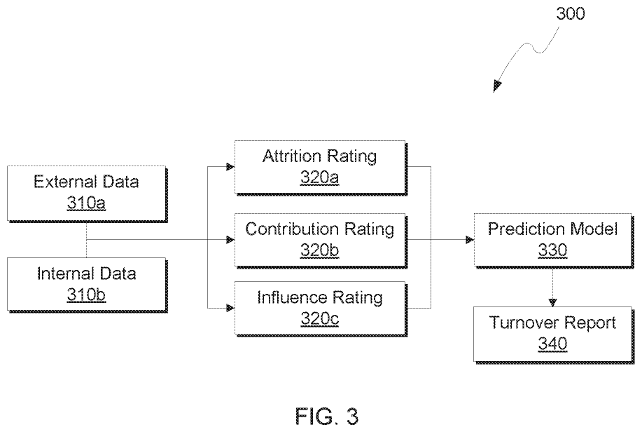

FIG. 3 depicts a block diagram, generally designated 300, of generating turnover report 340. As discussed herein, turnover program 112 retrieves internal data 310a and external data 310b from internal records maintained by the organization and external records maintained by data source(s) 120. Turnover program 112 determines attrition rating 320a, contribution rating 320b and influence rating 320c for each employee that turnover report 340 is being generated to report. In some scenarios, attrition rating 320a, contribution rating 320b and influence rating 320c may be determined for employees outside the scope of turnover report 340. For example, in a collaborative work environment a report for a single department may need to include employees outside of the department since the impact of work may impact others.

Turnover program 112 populates prediction model 330 with the ratings of each employee. As discussed above in process 212 of FIG. 2, prediction model 330 is a graph-based model with each employee as a node and paths indicating the interactions among employees (e.g., a path between employee A and employee B indicates that they influence each other's work). For each employee likely to leave (i.e., the attrition rating for the employee exceeds a predetermined value), the impact of the employee leaving is propagated based on the contribution and influence rating of the to-be-leaving employee to the other employees connected in model data 118. Based on the above analysis, turnover program 112 generates turnover report 340 indicating expected attrition, in addition to attrition that may occur based on the turnover of certain employees (e.g., influenced-based attrition).

FIG. 4 depicts a block diagram, 400, of components of computing device 110 and data source(s) 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 and data source(s) 120 each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Turnover program 112, employee data 116, organization data 117, model data 118 or employee data 122 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 130. In these examples, communications unit 410 includes one or more network interface cards. Communications unit 410 may provide communications through the use of either or both physical and wireless communications links. Turnover program 112, employee data 116, organization data 117, model data 118 and employee data 122 may be downloaded to persistent storage 408 through communications unit 410.

I/O interface(s) 412 allows for input and output of data with other devices that may be connected to computing device 110 and data source(s) 120. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., turnover program 112, employee data 116, organization data 117, model data 118 or employee data 122, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method comprising:
retrieving, by one or more processors, information regarding a plurality of employees of an organization;
determining, by the one or more processors, an attrition rating for each of the plurality of employees;
determining, by the one or more processors, a contribution rating for each of the plurality of employees;
determining, by the one or more processors, an influence rating for each of the plurality of employees;
responsive to a determination that the attrition rating for a first employee is above a predetermined threshold, updating, by the one or more processors, the attrition rating for each employee of a group of employees impacted by the first employee based, at least in part, on the influence rating for the first employee; and
generating, by the one or more processors, a predicted attrition report for the plurality of employees based, at least in part, on the attrition rating, the contribution rating, and the influence rating for each of the plurality of employees.

2. The method of claim 1, wherein the attrition rating for each of the plurality of employees is based, at least in part, on one or more of the following information regarding the plurality of employees: (i) current band, grade or step within the organization, (ii) joining band or grade, (iii) date of joining, (iv) work and education experience, (v) current assignment in the organization, and (vi) employee type.

3. The method of claim 1, wherein the contribution rating for each of the plurality of employees is based, at least in part, on one or more of the following information regarding the plurality of employees: (i) profit or revenue contribution of each employee or (ii) position or responsibilities of the employee.

4. The method of claim 1, wherein the influence rating for each of the plurality of employees is based, at least in part, on one or more of the following information regarding the plurality of employees: (i) followers in a social network or forum, (ii) publications or articles created by an employee, (iii) publications or articles mentioning the employee, and (iv) impact the employee has within the organization.

5. (canceled)

6. The method of claim 1, wherein the influence rating for each of the plurality of employees is based, at least in part, on an importance of tasks performed by the plurality of employees.

7. The method of claim 1, wherein the attrition rating for an employee is based on sentiment analysis of one or more messages made by the employee.

8. A computer program product comprising:
one or more computer-readable storage media and program instructions stored on the one or more computer-readable storage media, the program instructions comprising:
program instructions to retrieve information regarding a plurality of employees of an organization;
program instructions to determine an attrition rating for each of the plurality of employees;
program instructions to determine a contribution rating for each of the plurality of employees;
program instructions to determine an influence rating for each of the plurality of employees;
responsive to a determination that the attrition rating for a first employee is above a predetermined threshold, program instructions to update the attrition rating for each employee of a group of employees impacted by the first employee based, at least in part, on the influence rating for the first employee; and
program instructions to generate a predicted attrition report for the plurality of employees based, at least in part, on the attrition rating, the contribution rating, and the influence rating for each of the plurality of employees.

9. The computer program product of claim 8, wherein the attrition rating for each of the plurality of employees is based, at least in part, on one or more of the following information regarding the plurality of employees: (i) current band, grade or step within the organization, (ii) joining band or grade, (iii) date of joining, (iv) work and education experience, (v) current assignment in the organization, and (vi) employee type.

10. The computer program product of claim 8, wherein the contribution rating for each of the plurality of employees is based, at least in part, on one or more of the following information regarding the plurality of employees: (i) profit or revenue contribution of each employee or (ii) position or responsibilities of the employee.

11. The computer program product of claim 8, wherein the influence rating for each of the plurality of employees is based, at least in part, on one or more of the following information regarding the plurality of employees: (i) followers in a social network or forum, (ii) publications or articles created by an employee, (iii) publications or articles mentioning the employee, and (iv) impact the employee has within the organization.

12. (canceled)

13. The computer program product of claim 8, wherein the influence rating for each of the plurality of employees is based, at least in part, on an importance of tasks performed by the plurality of employees.

14. The computer program product of claim 8, wherein the attrition rating for an employee is based on sentiment analysis of one or more messages made by the employee.

15. A computer system comprising:
one or more computer processors;
one or more computer readable storage media; and
program instructions stored on the computer readable storage media for execution by at least one of the one or more processors, the program instructions comprising:
program instructions to retrieve information regarding a plurality of employees of an organization;
program instructions to determine an attrition rating for each of the plurality of employees;
program instructions to determine a contribution rating for each of the plurality of employees;
program instructions to determine an influence rating for each of the plurality of employees;
responsive to a determination that the attrition rating for a first employee is above a predetermined threshold, program instructions to update the attrition rating for each employee of a group of employees impacted by the first employee based, at least in part, on the influence rating for the first employee; and
program instructions to generate a predicted attrition report for the plurality of employees based, at least in part, on the attrition rating, the contribution rating, and the influence rating for each of the plurality of employees.

16. The computer system of claim 15, wherein the attrition rating for each of the plurality of employees is based, at least in part, on one or more of the following information regarding the plurality of employees: (i) current band, grade or step within the organization, (ii) joining band or grade, (iii) date of joining, (iv) work and education experience, (v) current assignment in the organization, and (vi) employee type.

17. The computer system of claim 15, wherein the contribution rating for each of the plurality of employees is based, at least in part, on one or more of the following information regarding the plurality of employees: (i) profit or revenue contribution of each employee or (ii) position or responsibilities of the employee.

18. The computer system of claim 15, wherein the influence rating for each of the plurality of employees is based, at least in part, on one or more of the following information regarding the plurality of employees: (i) followers in a social network or forum, (ii) publications or articles created by an employee, (iii) publications or articles mentioning the employee, and (iv) impact the employee has within the organization.

19. (canceled)

20. The computer system of claim 15, wherein the influence rating for each of the plurality of employees is based, at least in part, on an importance of tasks performed by the plurality of employees.
